(19) United States
(12) Patent Application Publication
(10) Pub. No.: US 2010/0154055 A1
(43) Pub. Date: Jun. 17, 2010

(54) Prefix Domain Matching for Anti-Phishing Pattern Matching

(75) Inventor: Tony Lee Hansen, South Amboy, NJ (US)

Correspondence Address: AT & T Legal Department - WS;Attn: Patent Docketing, Room 2A-207, One AT & T Way, Bedminster, NJ, 07921, US

(73) Assignee: AT&T INTELLECTUAL PROPERTY I, L.P., Reno, NV (US)

(21) Appl. No.: 12/333,701

(22) Filed: Dec. 12, 2008

(51) Int. Cl. G06F 21/00; G06F 17/30

(52) U.S. Cl. 726/22; 707/E17.014; 707/E17.005

(57) ABSTRACT

Phishing uniform resource locators are detected and/or filtered. After a uniform resource locator is received, it is determined if at least a portion of a prefix of the uniform resource locator matches at least a portion of a blacklist entry and the uniform resource locator is filtered if at least a portion of the prefix of the uniform resource locator matches at least a portion of the blacklist entry. The prefix of the uniform resource locator is constrained to be a predetermined number of the highest level domain labels of the domain name in the received uniform resource locator.

### BACKGROUND OF THE INVENTION

The present invention relates generally to pattern matching and more particularly to using prefix domain matching for anti-phishing pattern matching.

Internet users are at risk of harm from increasingly sophisticated attackers. These attackers use electronic mail (email) to attempt to gain access to sensitive personal information of Internet users. One avenue of attack is through the use of “phishing” emails.

Phishing is an attempt to fraudulently acquire sensitive information, such as usernames, passwords, credit card details, and the like, by masquerading as a trustworthy entity in an electronic communication. Phishing attackers often invoke (e.g., spoof, etc.) common commerce websites, such as the Internal Revenue Service, PayPal, eBay, financial institutions, and the like, or other websites that are likely to be trusted to gain access to the sensitive customer information. Phishing is typically carried out by email and often directs users, via clickable hyperlinks (e.g., links), to enter at a website personal details such as passwords, banking information, credit card information, and the like.

Most methods of phishing use some form of technical deception designed to make a link in an email and the spoofed website it leads to appear to belong to the spoofed organization. Misspelled Uniform Resource Locators (URLs) or the use of subdomains (e.g., higher-level domain names) are common tricks used by phishers. An exemplary phishing URL is http://signin.yourbank.example.com/resource/something?argument, where “http” is the protocol, “com” is the top-level domain name (TLDN), “example” is the second-level domain label (also known as the host name label), “yourbank” and “signin” are higher-level domain labels, “resource/path” is the resource part (e.g., directories, etc.), also known as path information, and “?argument” is the argument. In this example, example.com is a second-level domain name, and yourbank.example.com and signin.yourbank.example.com are higher level domain names. In this example, a user is drawn to the familiar “yourbank” domain label and may be fooled into believing the link will direct them to a website operated by their bank. Instead, the user will be directed to a website associated with the phisher who owns the example.com domain. Phishers may also use similar tricks in the path information.

To combat phishing, a common method of anti-phishing is to employ the use of one or more blacklists. Generally, a blacklist is a list, database, or other repository of known and/or determined abusive URLs or portions of URLs. The blacklists include known phishing complete URLs (e.g., http://www.signin.yourbank.example.com/path?arguments), known phishing second-level domain names (e.g., example.com), and/or known portions of phishing URLs (e.g., yourbank.example.com). Typically, listings are added to the blacklists as URLs and/or domains and are identified as phishing URLs and/or domains.

Incoming emails (e.g., emails sent to and/or received at a user) are compared with the blacklist to identify phishing emails. This may be accomplished by directly comparing an entire URL in an incoming email to the blacklist. That is, the blacklist may be queried and/or searched for an identical URL. Alternatively, a portion of the URL is compared with entries in the blacklist. For example, in an exemplary URL http://prefix1.prefix2.prefix3.example.com, entries in the database would be searched for patterns matching “prefix1.prefix2.prefix3.example.com”, “prefix2.prefix3.example.com”, “prefix3.example.com”, and “example.com”. A pattern match would then be performed to detect wildcard variations within these domains.

Phishing attackers have countered such conventional approaches by introducing numerous random sequences into the phishing URLs and randomizing the second- or higher-level domain labels. In this way, they are able to produce individual URLs for each user under attack. For example, phishing attackers take advantage of domain name tasting services to randomly apply for, and use for a short time, temporary domain names or may use stolen credit card information or other nefarious means to temporarily acquire access to domain names. Adding each determined phishing URL to the blacklist severely bloats the blacklist and, due to the infinite randomization in higher-level domains, present systems are unable to snare all of the phishing URLs. Further, even if the domains are determined to be phishing domains and added to the blacklist, they are never used again by the phishing attacker, so the blacklist is ineffective and full of useless entries.

Additionally, sophisticated phishing attackers register domain names and use wildcards (e.g., randomly generated terms) as the higher order domain labels (e.g., *.example.com, etc.) in the Domain Name System (DNS) database. In this way, the attackers can insert deceptive higher-level domain labels in their URLs to confuse users. However, since the second-level domain label (e.g., example in example.com) may also be randomized, the present methods are unable to detect phishing URLs unless the second-level domain name is already known to be a phishing domain. As such, by the time a URL is designated as a phishing URL and the root domain is designated as a phishing domain, it is usually too late and users have been exposed to the phishing emails and have possibly disclosed sensitive information.

Accordingly, improved systems and methods for filtering phishing URLs are required.

### BRIEF SUMMARY OF THE INVENTION

The present invention generally provides methods for detecting and/or filtering phishing uniform resource locators, emails, and the like. In one embodiment, uniform resource locators are filtered. After a uniform resource locator is received, if it is determined that at least a portion of a prefix of the uniform resource locator matches at least a portion of a blacklist entry, the uniform resource locator is filtered. The prefix of the uniform resource locator is generally constrained to be a predetermined number of the highest level domain names in the received uniform resource locator.

In another embodiment, after a uniform resource locator is received, it is determined if a prefix of a blacklist entry matches at least a portion of the received uniform resource locator. If a match is found, the uniform resource locator is filtered.

In still another embodiment, after a uniform resource locator is filtered based on its prefix and one or more blacklist entries, the filtered uniform resource locator is used to determine a prefix pattern. The blacklist is then updated with the determined prefix pattern.

These and other advantages of the invention will be apparent to those of ordinary skill in the art by reference to the following detailed description and the accompanying drawings.

### BRIEF DESCRIPTION OF THE DRAWINGS

FIG. 1 depicts an anti-phishing system according to an embodiment of the present invention;

FIG. 2 is a schematic drawing of a computer;

FIG. 3 depicts a flowchart of a method of filtering uniform resource locators according to an embodiment of the present invention;

FIG. 4 depicts a flowchart of a method of filtering uniform resource locators according to an embodiment of the present invention; and

FIG. 5 depicts a flowchart of a method of populating a uniform resource locator blacklist according to an embodiment of the present invention.

### DETAILED DESCRIPTION

At least one embodiment of the present invention provides mechanisms for using a blacklist based anti-phishing database to search for a set of phishing URLs (e.g., universal resource identifiers) based on domain prefix matching. Random sequences, both in the higher-level domain names as well as in the second-level domain name, are addressed.

As used herein, a uniform resource locator (URL) refers to a string of terms separated by slashs used to represent a location of a resource (e.g., a website) on the Internet. One of these terms is a domain name. URL is used interchangeably with uniform resource identifier (URI) to refer to both the location of the resource as well as a mechanism to reach the resource. Domains, domain names, domain labels, and levels of domain names refer to domain name related information as understood according to the Domain Name System (DNS) and as generally represented in a URL as a string of letter and/or number combinations (e.g., a term) separated by dots (e.g., a period). For example, an exemplary URL is http://patent.appplication1.example567.financial.bank.com, where patent, application1, example567, financial, and bank are all higher-level domain labels (e.g., forming higher-level domain names when used together), corn is the top-level domain name, and bank.com, financial.bank.com, example567.financial.bank.com, etc., are second-level, third-level and higher domain names. A subdomain is a domain name at a higher level than its shorter versions (e.g., financial.bank.com is a subdomain of bank.com, which in turn is a subdomain of corn).

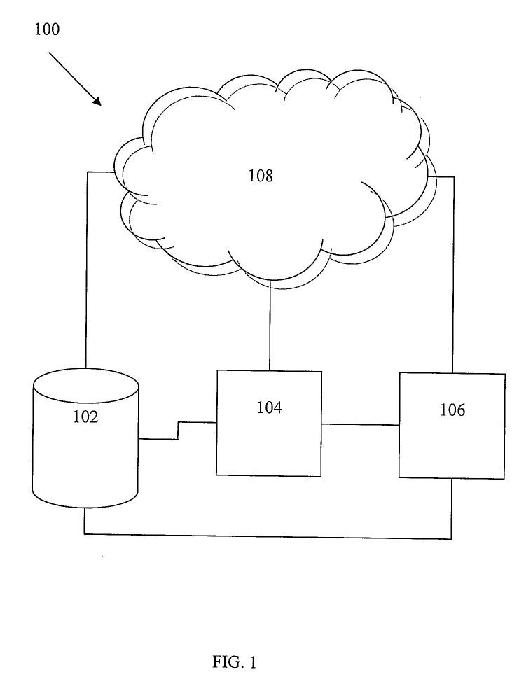

FIG. 1 depicts an anti-phishing system 100 according to an embodiment of the present invention. Anti-phishing system 100 includes a blacklist database 102. In some embodiments, blacklist database 102 is stored at an email server 104. In other embodiments, blacklist database 102 is stored at a client 106. In still other embodiments, blacklist database 102 is stored at another location, such as a remote server, along with an Internet web browser, etc.

Client 106 may be in communication with (e.g., may be connected to) email server 104 such that it may send emails to and/or receive emails from email server 104. In some embodiments, these emails may be transmitted across network 108.

Email server 104 and/or client 106 may be in communication with blacklist database 102. In some embodiments, email server 104 and/or client 106 may communicate with blacklist database across network 108.

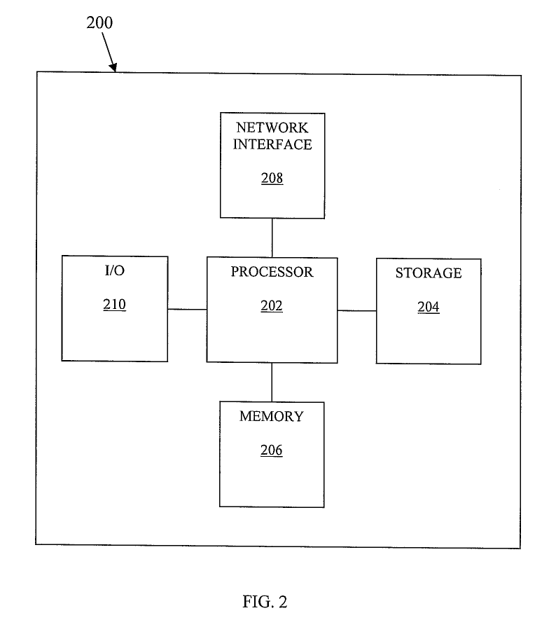

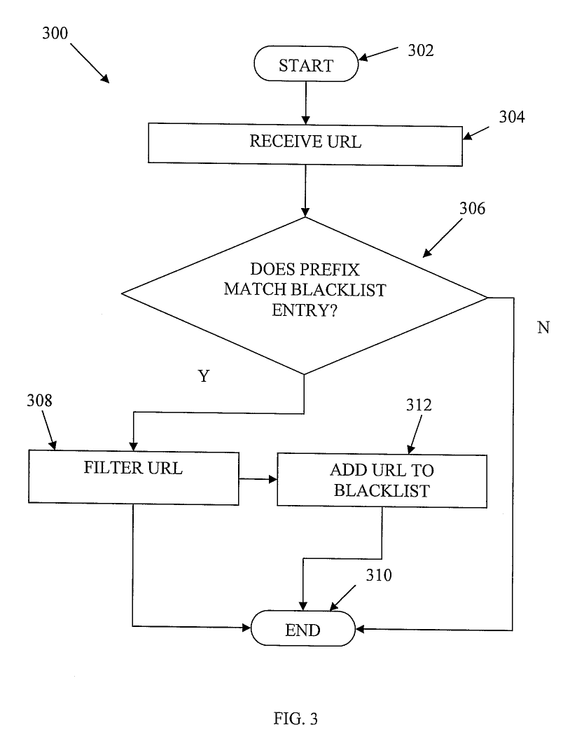

Blacklist database 102 may be any appropriate structured collection of records. In at least one embodiment, the blacklist database 102 is a collection of entries related to blacklisted domains, portions of URLs, and/or complete URLs as described in further detail below with respect to FIGS. 3-5. Though depicted and described herein as a separate entity, one of skill in the art would appreciate that blacklist database 102 may be incorporated into another structure, such as a memory of email server 104, client 106, or another computer (e.g., memory 200 of computer 200 in FIG. 2 below).

Email server 104 may be any appropriate computer, system of computers, server, or the like capable of managing email as is known and/or filtering email as is described in detail below with respect to FIGS. 3-5. In at least one embodiment, email server 104 is a computer with similar features to computer 200 described below with respect to FIG. 2.

Client 106 may be any appropriate computer, system of computers, user interface, personal computer, mobile device, or the like capable of receiving email as is known and/or filtering email as is described in detail below with respect to FIGS. 3-5. In at least one embodiment, client 106 is a computer with similar features to computer 200 described below with respect to FIG. 2.

Network 108 may be any appropriate transmission network, such as the Internet, etc., capable of transmitting emails from outside sources to email server 104 and/or client 106. Additionally, network 108 may be capable of facilitating information transmission to and/or from blacklist database 102.

FIG. 2 is a schematic drawing of a computer 200 according to an embodiment of the invention. Computer 200 may be used in conjunction with and/or may perform the functions email server 104 and/or client 106 of anti-phishing system 100 and/or the method steps of methods 300, 400, and/or 500.

Computer 200 contains a processor 202 that controls the overall operation of the computer 200 by executing computer program instructions, which define such operation. The computer program instructions may be stored in a storage device 204 (e.g., magnetic disk, database, etc.) and loaded into memory 206 when execution of the computer program instructions is desired. Thus, applications for performing the herein-described method steps, such as URL filtering in methods 300, 400, and/or 500 are defined by the computer program instructions stored in the memory 206 and/or storage 204 and controlled by the processor 202 executing the computer program instructions. The computer 200 may also include one or more network interfaces 208 for communicating with other devices via a network. The computer 200 also includes input/output devices 210 (e.g., display, keyboard, mouse, speakers, buttons, etc.) that enable user interaction with the computer 200. Computer 200 and/or processor 202 may include one or more central processing units, read only memory (ROM) devices and/or random access memory (RAM) devices. One skilled in the art will recognize that an implementation of an actual computer could contain other components as well, and that the controller of FIG. 2 is a high level representation of some of the components of such a controller for illustrative purposes.

According to some embodiments of the present invention, instructions of a program (e.g., controller software) may be read into memory 206, such as from a ROM device to a RAM device or from a LAN adapter to a RAM device. Execution of sequences of the instructions in the program may cause the computer 200 to perform one or more of the method steps described herein, such as those described above with respect to methods 300, 400, and/or 500. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory 206 may store the software for the computer 600, which may be adapted to execute the software program and thereby operate in accordance with the present invention and particularly in accordance with the methods described in detail above. However, it would be understood by one of ordinary skill in the art that the invention as described herein could be implemented in many different ways using a wide range of programming techniques as well as general purpose hardware sub-systems or dedicated controllers.

Such programs may be stored in a compressed, uncompiled, and/or encrypted format. The programs furthermore may include program elements that may be generally useful, such as an operating system, a database management system, and device drivers for allowing the controller to interface with computer peripheral devices, and other equipment/components. Appropriate general purpose program elements are known to those skilled in the art, and need not be described in detail herein.

FIG. 3 shows a flowchart of a method 300 of filtering uniform resource locators according to an embodiment of the present invention. A URL may be filtered at email server 104, client 106, or any other appropriate location and may be filtered by using entries in blacklist database 102. The method 300 begins at step 302.

In step 304, a URL is received. The URL may be received at email server 104 or client 106. In at least one embodiment, the URL is received with an email. That is, a URL may be embedded in, attached to, and/or otherwise associated with an email transmitted to (e.g., over network 108) and received at email server 104 and/or client 106.

In many instances, phishing URLs (e.g., URLs sent with malicious intent to deceive a user into disclosing sensitive material) have the name (or domain name) of a familiar entity near the beginning of the URL. For example, the domain name of a phishing URL may lead with “signin.yourbank.com.portal.money” or “logon.ybonline.com.portal.transfer”, where “Your Bank” is the familiar entity and “YB Online” is a known website for the entity. Of course, phishing attackers may use many other devices, orders, wildcards, and/or randomized higher-level domain labels to deceive users, but often put domain labels that “seem” real in the highest (e.g., furthest from the root or top-level domain) level of the domain names, so that they are seen first by unsuspecting users.

Additionally, to conceal the intent and/or actual address, phishing URLs often have a high “dot count.” That is, they include large numbers (e.g., four or more) of domain labels separated by dots. An exemplary phishing URL may be: http://signin.yourbank.com.portal.money.34lkju.3246765.user.example.com.

In step 306, a determination is made as to whether at least a portion of a prefix of the URL matches at least a portion of a blacklist entry in blacklist database 102. As used herein, a prefix of a URL is a particular (e.g., predetermined) number of the highest-level domain labels in the URL. In at least one embodiment, the prefix used in the determination is defined as the three highest level domain labels in the URL. In the exemplary phishing URL described immediately above, “signin.yourbank.com” would be the three highest level domain labels and thus, in embodiments using the three highest level domain labels as the prefix, would be the prefix. Of course, other numbers (e.g., one, two, four, etc.) of domain labels may be considered to be the prefix.

If the prefix matches a blacklist entry, the method proceeds to step 308 and the URL is filtered. Filtering may include, for example, blocking an email associated with the URL, blocking the URL within a web browser, expunging the email and/or the URL, flagging (e.g., identifying) the URL to a blacklist service (e.g., over network 108, at email server 106, etc.), or any other appropriate action.

If the prefix does not match the blacklist entry, the method proceeds to step 310 and the method ends. As described below, the prefix may be compared with multiple blacklist entries and thus step 308 may repeat.

In some embodiments portions of the URL are compared to blacklist entries. That is, one or more domain names, alone or in combination, that form the prefix of the URL may be additionally compared to blacklist entries. For example, if the prefix is “signin.yourbank.com”, the additional terms “signin”, “yourbank”, “com”, “signin.yourbank”, “signin.com”, and “yourbank.com” may also be compared to blacklist entries in step 308. Multiple comparisons may be performed simultaneously, substantially simultaneously, and/or in series. In this way, multiple determinations may be made at step 306 and a URL will only be considered as not a phishing URL if all such determinations indicate that the URL is not a phishing URL. Thereafter, the method proceeds to step 310 and ends. If any of the determinations indicates that the URL is or may be a phishing URL, the URL and/or any associated email message is filtered in step 308.

In some embodiments, after filtering in method step 308, the method ends at step 310. In alternative embodiments, the URLs or portions of the URLs filtered in step 308 are added to the blacklist database 102 in step 312. The method then ends at step 310.

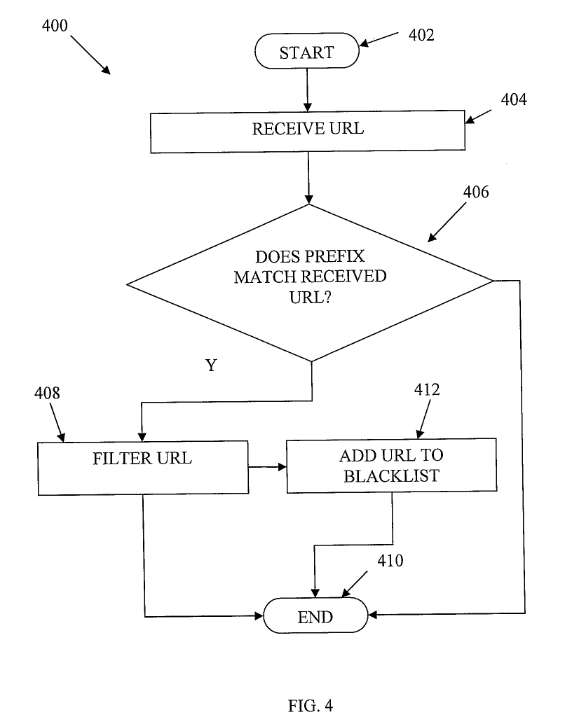

FIG. 4 depicts a flowchart of a method 400 of filtering uniform resource locators according to an embodiment of the present invention. A URL may be filtered at email server 104, client 106, or any other appropriate location and may be filtered by using entries in blacklist database 102. The method 400 begins at step 402.

In step 404, a URL is received. Receiving the URL in step 404 is similar to or the same as receiving the URL in step 304 described above. An exemplary URL is http://stuff1.prefix1.stuff2.prefix2.prefix3.example.com.

In step 406, a determination is made as to whether at least a portion of a prefix of a blacklist entry matches at least a portion of the received URL. That is, in contrast to method 300, prefixes (e.g., a predetermined subset of the highest level domain labels of a URL) of the URLs (or portions of URLs) in the blacklist database 102 are compared to portions of a potential phishing URL. For example, if a blacklist entry is prefix1.prefix2.prefix3.phisher.com, “prefix1.prefix2.prefix3”, or a portion thereof, may be compared to the entire URL received in step 404. In this example, the received URL may be determined as a “match” based on the “prefix2.prefix3” domain name string in the URL.

In step 408, URLs determined to match at least a portion of a blacklist entry in method step 406 are filtered. Filtering may include, for example, blocking an email associated with the URL, blocking the URL within a web browser, expunging the email and/or the URL, flagging (e.g., identifying) the URL to a blacklist service (e.g., over network 108, at email server 106, etc.), or any other appropriate action.

If the prefix of the blacklist entry does not match any portion of the uniform resource locator received in step 404, the method proceeds to step 410 and the method ends.

In some embodiments, after filtering in method step 408, the method ends at step 410. In alternative embodiments, the URLs or portions of the URLs filtered in step 408 are added to the blacklist database 102 in step 412. The method then ends at step 410.

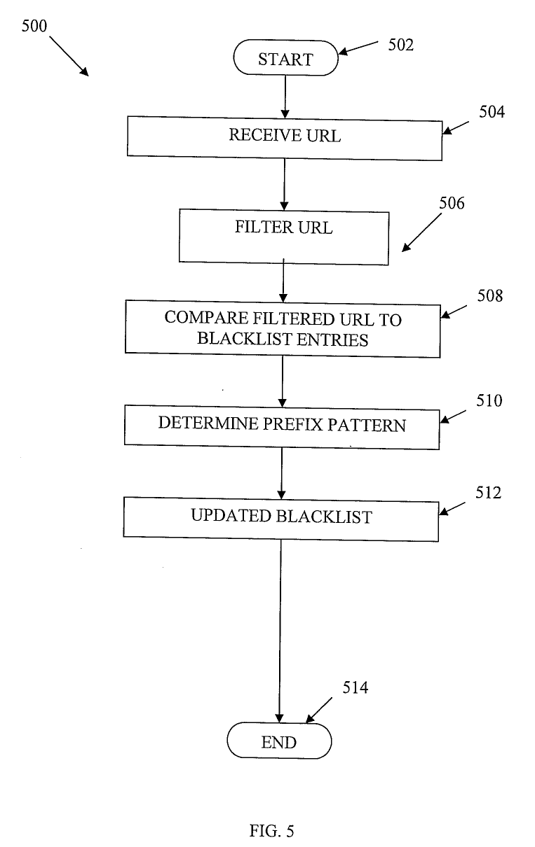

FIG. 5 depicts a flowchart of a method 500 of populating a uniform resource locator blacklist according to an embodiment of the present invention. The blacklist may be stored at or otherwise reside at blacklist database 102. The method begins at step 502.

In step 504, a URL is received. Receiving the URL in step 504 is similar to or the same as receiving the URL in steps 304 and/or 404 as described above.

In step 506, the uniform resource locator received in step 504 is filtered if a prefix of the URL matches a blacklist entry. Prefixes and criterion for “matching” are described above in greater detail with respect to FIGS. 3 and 4. Filtering may include, for example, blocking an email associated with the URL, blocking the URL within the email, expunging the email and/or the URL, flagging (e.g., identifying) the URL to a blacklist service (e.g., over network 108, at email server 106, etc.), or any other appropriate action.

In step 508, the filtered URL is compared to multiple blacklist entries in blacklist database 102. That is, at least a portion of the filtered URL (e.g., a prefix, etc.) is checked against domain names in the blacklist.

In step 510, a prefix pattern is determined based on the comparison of the filtered uniform resource locator to the plurality of blacklist entries. That is, the new prefix of the filtered URL is used along with previously acquired prefixes in the blacklist to find commonalities in the domain names, the ordering of domain labels and/or the usage of wildcard terms. Such a prefix pattern may be a simple pattern, such as a predetermined number of the highest level domain labels. The prefix pattern could be a more complex pattern including wildcards. For example, based on the comparison in step 508, it may be determined that a phishing attacker is adding a wildcard character, represented herein by an asterisk, to a portion of a domain name such as mybank*.signin.com.ghost. In another example, based on the comparison in step 508, it may be determined that a phishing attacker is adding a wildcard domain such as mybank.*.signin .com.ghost.

In step 512, the blacklist is updated with the determined pattern. In other words, the pattern (e.g., a prefix pattern as discussed above with respect to step 510) is added to the blacklist entries in blacklist database 102. Thus, the prefix pattern may be available for future pattern matching and phishing detection, such as the filtering of methods 300 and 400 above. The method ends at step 514.

Using the methods described above, blacklist size may be reduced. Such prefix matching and/or searching requires fewer entries in the database to find the same amount of phishing URLs. As a result, redundant entries may be removed from a blacklist database (e.g., blacklist database 102, etc.). Thus, the search space and time is also reduced.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of filtering uniform resource locators comprising:
receiving a uniform resource locator;
determining if a prefix of the uniform resource locator matches at least a portion of a blacklist entry; and
filtering the uniform resource locator if the prefix of the uniform resource locator matches at least a portion of the blacklist entry.

2. The method of claim 1 wherein the uniform resource locator comprises a plurality of domain names and the prefix of the uniform resource locator comprises a predetermined number of the highest level domain labels.

3. The method of claim 2 wherein the prefix of the uniform resource locator comprises the predetermined number of highest level domain labels.

4. The method of claim 1 wherein determining if the prefix of the uniform resource locator matches at least a portion of a blacklist entry comprises comparing at least a portion of the prefix of the uniform resource locator to at least a portion of a uniform resource locator entry in the blacklist.

5. The method of claim 1 further comprising:
adding the filtered uniform resource locator to a blacklist.

6. The method of claim 1 further comprising:
adding a portion of the filtered uniform resource locator to a blacklist.

7. A machine readable medium having program instructions stored thereon, the instructions capable of execution by a processor and defining the steps of:
receiving a uniform resource locator;
determining if a prefix of the uniform resource locator matches at least a portion of a blacklist entry; and
filtering the uniform resource locator if the prefix of the uniform resource locator matches at least a portion of the blacklist entry.

8. The machine readable medium of claim 7 wherein the uniform resource locator comprises a plurality of domain names and the prefix of the uniform resource locator comprises a predetermined number of the highest level domain labels.

9. The machine readable medium of claim 8 wherein the prefix of the uniform resource locator comprises the predetermined number of highest level domain labels.

10. The machine readable medium of claim 7 wherein the instructions for determining if the prefix of the uniform resource locator matches at least a portion of a blacklist entry further defines the step of:
comparing at least a portion of the prefix of the uniform resource locator to at least a portion of a uniform resource locator entry in the blacklist.

11. The machine readable medium of claim 7 wherein the instructions further define the step of:
adding the filtered uniform resource locator to a blacklist.

12. The machine readable medium of claim 7 wherein the instructions further define the step of:
adding a portion of the filtered uniform resource locator to a blacklist.

13. A method of populating a uniform resource locator blacklist comprising:
receiving a uniform resource locator;
filtering the uniform resource locator if a prefix of the uniform resource locator matches a portion of a blacklist entry;
comparing the filtered uniform resource locator to a plurality of blacklist entries;
determining a prefix pattern based on the comparison of the filtered uniform resource locator to the plurality of blacklist entries; and
updating the blacklist with the determined prefix pattern.
